(19) United States
(12) Patent Application Publication
(10) Pub. No.: US 2010/0238578 A1
(43) Pub. Date: Sep. 23, 2010

(54) METHOD FOR GENERATING WRITE CLOCK SIGNAL IN MAGNETIC DISK DRIVE

(75) Inventor: Hiroaki Ueno, Hachioji-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/727,112

(22) Filed: Mar. 18, 2010

(30) Foreign Application Priority Data
Mar. 19, 2009 (JP) 2009-068678

(51) Int. Cl. G11B 5/09

(52) U.S. Cl. 360/51; G9B/5.033

(57) ABSTRACT

According to one embodiment, a write clock generator writes data to bits in a magnetic recording medium based on a write clock signal with a phase obtained by delaying the phase of a reference write clock signal. The write clock generator detects the amplitude of a read signal for the written data. The write clock generator repeats these operations with a phase delay varied. The write clock generator decides an optimum phase delay based on the amplitude detected for each phase delay.

### CROSS-REFERENCE TO RELATED APPLICATIONS

This application is based upon and claims the benefit of priority from Japanese Patent Application No. 2009-068678, filed Mar. 19, 2009, the entire contents of which are incorporated herein by reference.

### BACKGROUND

1. Field

One embodiment of the invention relates to, for example, a method for generating a write clock signal and a magnetic disk drive to which the method is applied.

2. Description of the Related Art

In recent years, in order to improve the heat relaxation property of perpendicular magnetic recording, magnetic media called patterned media have been developed. The patterned medium is characterized in that isolated magnetic dots are regularly arranged in the circumferential direction of the medium. Each of the magnetic dots is called a land. In the patterned medium, one data bit (hereinafter simply referred to as a bit) comprises one or more magnetic dots.

In a magnetic disk drive comprising a patterned medium, data is written to the medium by applying a magnetic field to target lands arranged on the medium at timings when a write head sequentially arrives over the respective target lands. Thus, a write clock signal needs to be generated which synchronizes with the timing when the write head arrives over each of the target lands. This synchronization is referred to as write synchronization.

For example, Jpn. Pat. Appln. KOKAI Publication Nos. 2000-48352 and 2004-199806 disclose a technique (hereinafter referred to as a first prior technique) for generating a write clock signal based on a preamble. According to the first prior technique, for example, a preamble is written to the starting portion of each of the sectors on tracks in a disk. The preamble comprises data of a uniform frequency, that is, continuous pattern data (hereinafter referred to as a continuous pattern). In the first prior technique, when data is written to a disk, the preamble written to the starting portion of the target sector is detected. Then, based on the detected preamble, a write clock signal is generated.

Here, the continuous pattern forming the preamble synchronizes with the detected preamble (that is, a read signal for the preamble). Thus, the timing when data is written based on the write clock signal has the same frequency as that of the continuous pattern forming the preamble. However, the phases of the timing and the continuous pattern do not always match. Hence, achieving accurate write synchronization is difficult. The difficulty involves, for example, roughly two factors. A first factor is that a write head and a read head generally have different physical arrangements and configurations, resulting in a difference in delay between the write head and the read head. A second factor is that a write module corresponding to the write head comprises a circuit different from that of a read module corresponding to the read head, resulting in a difference in delay between the modules. Owing to the factors, even when the continuous pattern data forming the preamble synchronizes with the read signal for the preamble, the bits in the medium do not always synchronize with the timings when data is written to the medium.

Thus, for example, Jpn. Pat. Appln. KOKAI Publication No. 2006-164349 discloses a technique (hereinafter referred to as a second prior technique) to achieve write synchronization by delaying a write clock signal by such an amount as serves to optimize an error rate obtained when data written to the medium is read based on the write clock signal.

However, the second prior technique requires that the read module be optimized in order to determine the error rate. Moreover, to optimize the read module, synchronization needs to be established between the bits in the medium and the timings at which data is written to the medium. The second prior technique determines the error rate using a waveform equalizer configured to equalize reproduced waveforms in a partial response manner. However, the second prior technique does not necessarily optimize the waveform equalizer. Hence, determining the optimum error rate is difficult. Thus, even the second prior technique has difficulty synchronizing the bits in the medium with the timings at which data is written to the medium.

Furthermore, the write head and the write module differ in signal delay, the rise time of a write current, and even the gradient of a write magnetic field, because of the influence of ambient temperature. Thus, the synchronization between the bits in the medium and the write clock signal needs to be optimized in accordance with the ambient temperature.

Moreover, the write head and the read head are arranged at physically different positions on a slider. Furthermore, the slider is installed in a rotary actuator via a carriage. Hence, the distance between the write head and the read head in the circumferential direction of the medium varies depending on a radial position on the medium, that is, the yaw angle.

### BRIEF DESCRIPTION OF THE SEVERAL VIEWS OF THE DRAWINGS

A general architecture that implements various features of the invention will now be described with reference to the drawings. The drawings and their associated descriptions are provided to illustrate the embodiments of the invention and not to limit the scope of the invention.

FIG. 1 is a block diagram showing an exemplary configuration of a magnetic disk drive according to an embodiment of the invention;

FIG. 2 is a block diagram showing an exemplary configuration of a write clock generator applied to the embodiment;

FIG. 3 is a block diagram showing an exemplary configuration of a delay module applied to the embodiment;

FIG. 4 is a block diagram showing an exemplary configuration of a read/write module applied to the embodiment;

FIG. 5 shows an exemplary format of a patterned medium applied to the embodiment;

FIGS. 6A and 6B show an example of a repeated pattern and an example of a write current corresponding to the repeated pattern, respectively;

FIG. 7 shows an example of data stored in a memory and indicating the correspondence between temperature and phase delay;

FIGS. 8A and 8B show a first example of the relationship between the phase of a write magnetic field and the magnetization state of magnetic dots;

FIGS. 9A and 9B show a second example of the relationship between the phase of a write magnetic field and the magnetization state of magnetic dots;

FIGS. 10A and 10B show a third example of the relationship between the phase of a write magnetic field and the magnetization state of magnetic dots;

FIGS. 11A and 11B show the exemplary relationship between one magnetic dot and 1 bit in the patterned medium;

FIGS. 12A, 12B, and 12C show the exemplary relationship between a plurality of magnetic dots and 1 bit in the patterned medium;

FIG. 13 shows an example of the general relationship between the phase delay of the write magnetic field and the amplitude of a read signal;

FIG. 14 shows an example of the general relationship between the phase delay of the write magnetic field and the amplitude of a read signal which relationship is observed when the degree of jitter in the write magnetic field is different from that in FIG. 13;

FIG. 15 is a block diagram showing an exemplary configuration of an amplitude detector applied to a first modification of the embodiment;

FIG. 16 shows an example of data stored in the memory and including the phase delay according to a second modification of the embodiment;

FIG. 17 shows an example of data stored in the memory and including the phase delay according to a third modification of the embodiment;

FIG. 18 is a flowchart illustrating a write clock signal generating process according to the embodiment;

FIG. 19 is a flowchart illustrating a write clock signal generating process according to a fourth modification of the embodiment;

FIGS. 20 and 21 are a first portion and a second portion, respectively, of a flowchart illustrating a write clock signal generating process according to a fifth modification of the embodiment; and

FIGS. 22, 23 and 24 are diagrams showing an example of the result of detection of the signal amplitude corresponding to the degree of jitter in the write magnetic field.

### DETAILED DESCRIPTION

Various embodiments according to the invention will be described hereinafter with reference to the accompanying drawings. In general, according to one embodiment of the invention, there is provided a method for generating a write clock signal in a magnetic disk drive. The method comprises: generating a write clock signal with a phase delayed with respect to a reference write clock signal; writing predetermined data to bits in a magnetic recording medium based on the generated write clock signal, each of the bits comprising one or more of isolated magnetic dots arranged on the magnetic recording medium; detecting an amplitude of a read signal for the written predetermined data; controlling a repetition of the generating, the writing and the detecting with a phase delay varied; and deciding an optimum phase delay based on the amplitude detected for each phase delay, the optimum phase delay being used to generate the write clock signal when data is written to the magnetic recording medium after the deciding.

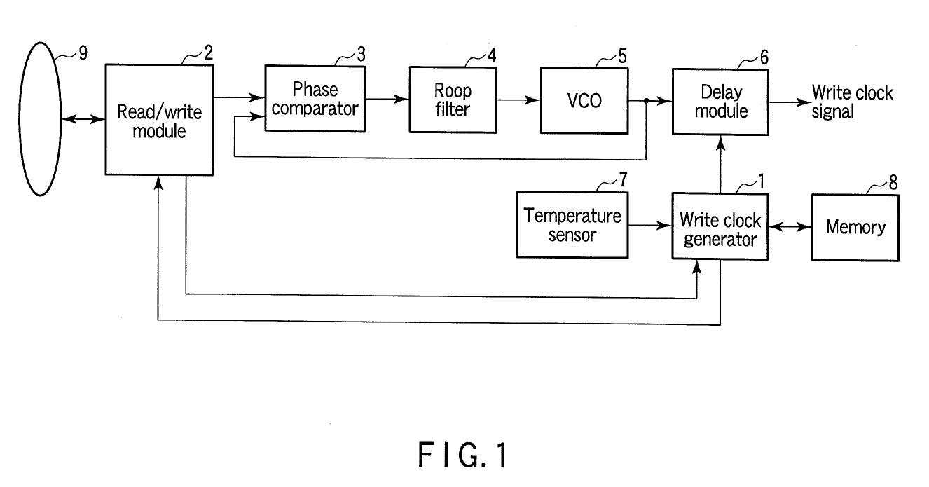

FIG. 1 is a block diagram showing the configuration of a magnetic disk drive according to an embodiment of the invention. The magnetic disk drive shown in FIG. 1 comprises a write clock generator 1, a read/write module 2, a phase comparator 3, a loop filter 4, a voltage controlled oscillator (VCO) 5, a delay module 6, a temperature sensor 7, a memory 8, and a patterned medium 9. The patterned medium 9 is a disk-shaped magnetic recording medium in which isolated dots (that is, lands) are arranged. One or more magnetic dots on the patterned medium 9 form 1 bit in the patterned medium 9.

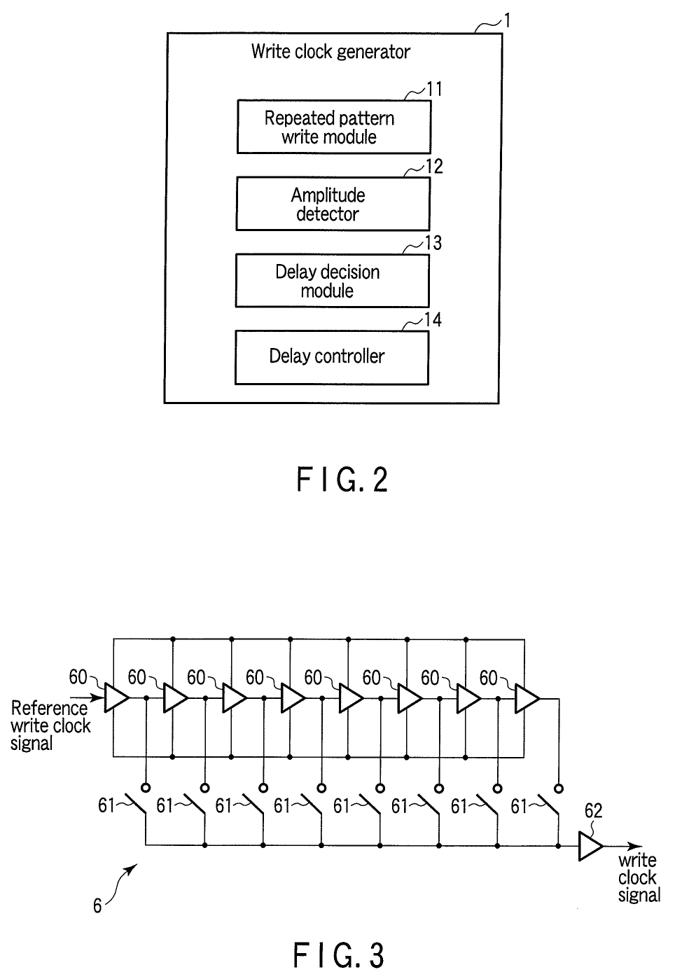

FIG. 2 is a block diagram showing the configuration of a write clock generator applied to the embodiment. The write clock generator 1 has the function of generating a write clock signal used to write data to bits (more specifically, the areas of the bits) in the patterned medium 9, based on a reference write clock signal. As shown in FIG. 2, the write clock generator 1 comprises a repeated pattern write module 11, an amplitude detector 12, a delay decision module 13, and a delay controller 14.

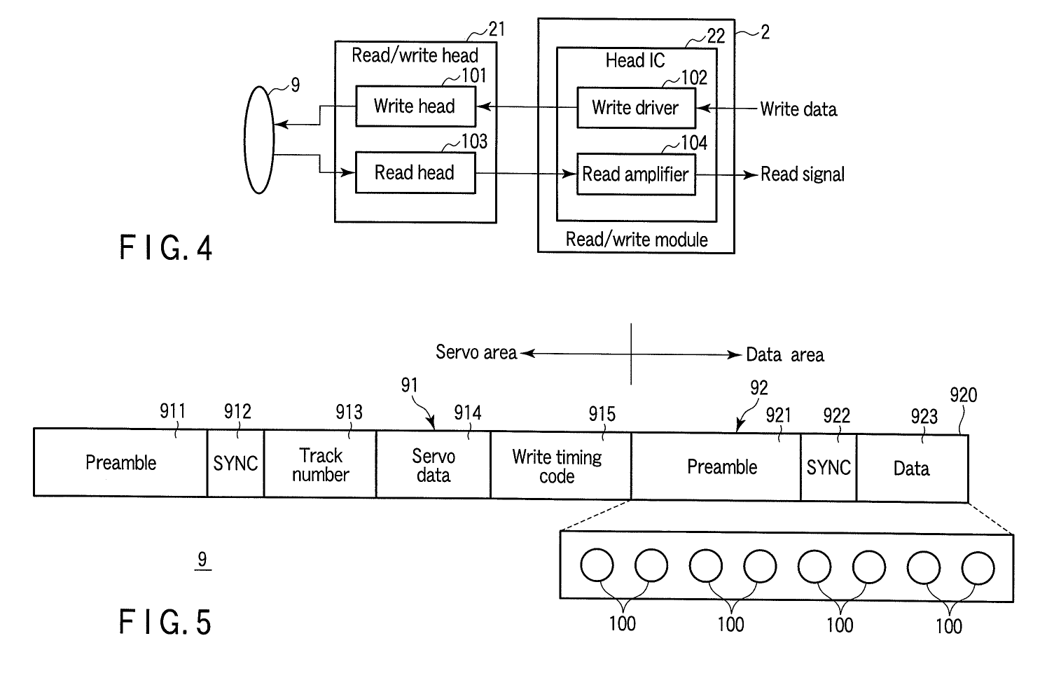

In the magnetic disk drive shown in FIG. 1, the read/write module 2 sequentially reads write timing codes written to servo areas on the patterned medium 9, via a read head 103 (see FIG. 4) described below. As is well known, the servo areas are arranged in a circular arc in the radial direction of the patterned medium 9 and at regular intervals in the circumferential direction of the medium 9. Data read from the servo areas by the read/write module 2 is input to the phase comparator 3. The write timing codes will be described below.

Furthermore, the read/write module 2 reads data written to a target data area on the patterned media 9. The data (read signal) read from the data area by the read/write module 2 is input to the amplitude detector 12 of the write clock generator 1. Additionally, the read/write module 2 writes data on a repeated pattern described below to the data area on the patterned medium 9 in accordance with an instruction from the repeated pattern write module 11 of the write clock generator 1.

As is well known, the phase comparator 3 outputs the difference between a read signal output by the read/write module 2 (more specifically, a read signal for a preamble read from a preamble section 921 described below) and an output from VCO 5. The loop filter 4 smoothes an output from the phase comparator 3. VCO 5 oscillates based on the output from the loop filter 4 to output a signal. The signal output by VCO 5 is called a reference write clock signal. The reference write clock signal output by VCO 5 is input to the delay module 6. As is well known, the read/write module 2, the phase comparator 3, the loop filter 4, and VCO 5 form a reference write clock generator configured to read data (preamble) written to the patterned medium 9 to generate a reference write clock signal based on the corresponding read signal.

The delay module 6 shifts the phase of the reference write clock signal input by VCO 5, by a phase delay specified in phase delay data. The delay module 6 outputs the reference write clock signal with the phase shifted, as a write clock signal. The phase delay data is provided by the delay controller 14 in the write clock generator 1.

FIG. 3 is a block diagram showing the configuration of the delay module 6 applied to the embodiment. The delay module 6 comprises a plurality of gates 60 cascaded to transmit the input reference write clock signal. The delay module 6 further comprises switches 61 provided in association with the respective plurality of gates 60, and a gate 62. One end of each of the switches 61 is connected to the output of the corresponding gate 60. The other end of each of the switches 61 is connected to the input of the gate 62. The plurality of gates 60 correspond to respective different phase delays. Upon receiving the phase delay data from the delay controller 14 in the write clock generator 1, the delay module 6 opens one or more gates 60 corresponding to the phase delay in accordance with the phase delay data. To open the one or more gates 60, the delay module 6 turns on one or more switches 61 corresponding to the one or more gates 60. Opening the one or more gates 60 allows a signal with a phase obtained by shifting the phase of the reference write clock signal by the phase delay to be output by the gate 62 as a write clock signal.

FIG. 4 is a block diagram mainly showing the configuration of the read/write module 2 applied to the embodiment. The read/write module 2 comprises a head IC 22. The head IC 22 comprises a write driver 102 and read amplifier 104. The head IC 22 reads data from the patterned medium 9 and writes data to the patterned medium 9, via the read/write head 21. The read/write head 21 comprises a write head 101 and a read head 103.

Write data with the timing controlled by the write clock signal is converted into a write current by the write driver 102 in the head IC 22. The write current is converted into a write magnetic filed by the write head 101 in the read/write head 21. The magnetization state corresponding to the write magnetic field is written to the patterned medium 9. On the other hand, the read head 103 in the read/write head 21 reads the magnetization state on the patterned medium 9 and converts the magnetization state into an electrical signal. The read amplifier 104 in the head IC 22 amplifies the signal and outputs the amplified signal as a read signal.

FIG. 5 shows an example of the format of the patterned medium 9, more specifically an example of the relationship between magnetic dots on the patterned medium 9 and 1 bit in the patterned medium. As shown in FIG. 5, a servo area 91 and a data area 92 are arranged in the patterned medium 9. More specifically, a plurality of servo areas are discretely arranged on the circumference of the patterned medium 9. A data area is located between the adjacent servo areas.

The servo area 91 mainly comprises a preamble section 911, a synchronization section (SYNC) 912, a track number section 913, servo data section 914, and write timing code section 915. Data used by the read/write module 2 to adjust amplitude, frequency, and phase (that is, the preamble) is pre-written to the preamble section 911. Data for servo synchronization is pre-written to the synchronization section 912. A servo track number is pre-written to the track number section 913. Data (servo data) used to position the read/write head 21 shown in FIG. 4 is pre-written to the servo data section 914. Data (write timing code) on the frequency of a pattern of bits in the patterned medium 9 corresponding to magnetic dots 100 formed in the data area 92 is pre-written to the write timing code section 915.

As shown in FIG. 5, the isolated magnetic dots 100 are formed in the data area 92. A plurality of data sectors including a data sector 920 is arranged in the data area 92. The data sector 920 mainly comprises a preamble section 921, a synchronization section (SYNC) 922, and data section 923. Data used by the read/write module 2 to adjust amplitude, frequency, and phase (that is, the preamble) is pre-written to the preamble section 921. Data indicative of the start position of data is written to the synchronization section 922. The data section 923 is an area where data is written. The repeated pattern write module 11 shown in FIG. 2 writes data with a repetition of “1” and “0”, that is, a repeated pattern, to the data section 923.

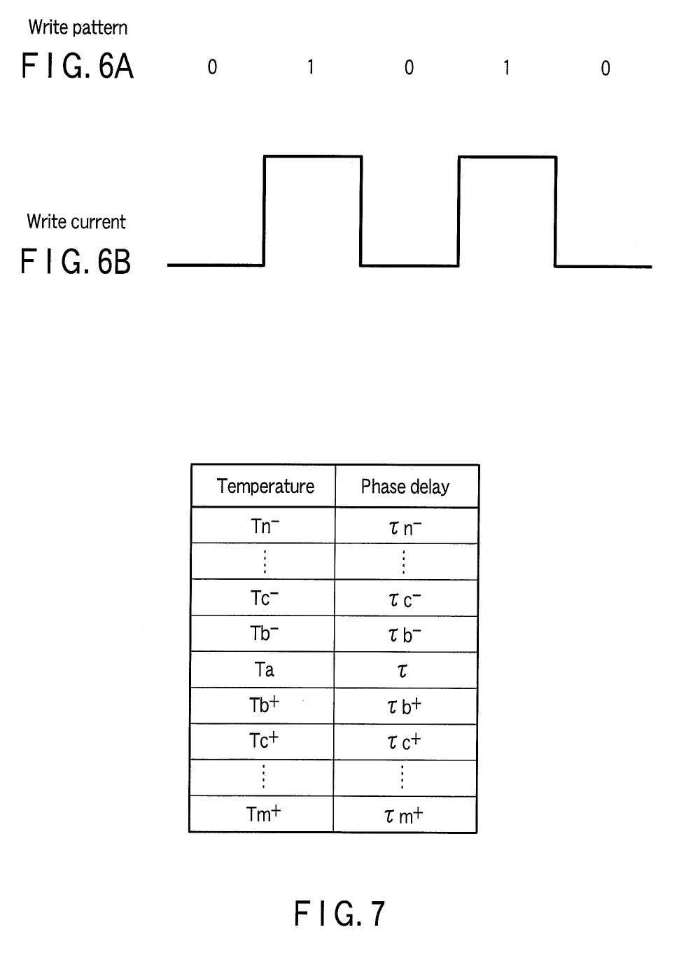

FIGS. 6A and 6B show an example of a repeated pattern and an example of a write current corresponding to the repeated pattern. The repeated pattern write module 11 instructs the write driver 102 in the read/write module 2 to output a write current shown in FIG. 6B and corresponding to, for example write pattern data (hereinafter referred to as a write pattern) “01010 . . . ” shown in FIG. 6A and having uniform frequency. Thus, the repeated pattern write module 11 writes the write pattern “01010 . . . ” to the patterned medium 9 (more specifically, the data section 923 in the data area shown in FIG. 5) as a repeated pattern (or repeated pattern data). Adoption of such a repeated pattern allows the amplitude detector 12 to accurately detect the amplitude of a read signal. The repeated pattern has only to be a write pattern of uniform frequency and may be, for example, a write pattern “0011001100 . . . ”.

The repeated pattern write module 11 may write a repeated pattern with a half period corresponding to the minimum unit of lands (that is, the distance between the adjacent lands). Alternatively, the repeated pattern write module 11 may write a repeated pattern with a half period corresponding to 1 bit in the data section 923 on the patterned medium 9.

Referring back to FIG. 2, the amplitude detector 12 detects the amplitude of a read signal obtained when the repeated pattern written to the patterned medium 9 is read. The delay decision module 13 decides the optimum phase delay for the reference write clock signal which is required synchronize the write clock signal with the lands (or bits) based on the amplitude of the detected read signal (that is, the read signal for the repeated pattern). The delay decision module 13 stores the decided phase delay in the memory 8 (see FIG. 1).

In the embodiment, based on the temperature of the magnetic disk drive detected by the temperature sensor 7, the amplitude detector 12 detects the amplitude of the read signal for the repeated pattern, for each temperature of the magnetic disk drive. The delay decision module 13 decides the phase delay for each temperature of the magnetic disk drive. The delay decision module 13 stores the decided phase delay in the memory 8 in association with the temperature. That is, the delay decision module 13 stores data indicative of the relationship between the temperature and the phase delay in the memory 8. FIG. 7 shows an example of data stored in the memory 8 and indicating the correspondence between the temperature and the phase delay.

The delay controller 14 shown in FIG. 2 reads the phase delay for the reference write clock signal from the memory 8. The delay control section 14 provides the delay module 6 with phase delay data corresponding to an instruction to shift the phase of the reference write clock signal by the read phase delay. Based on the phase delay data, the delay module 6 delays the phase of the reference write clock signal, that is, an output signal from VCO 5, by a specified phase delay to generate a write clock signal.

The temperature sensor 7 shown in FIG. 1 detects the temperature of the magnetic disk drive (that is, the ambient temperature), for example, the temperature in the magnetic disk drive. The memory 8 is used to store the optimum phase delay required to synchronize the write clock signal with the lands (bits) (more specifically, the optimum phase delay for each temperature).

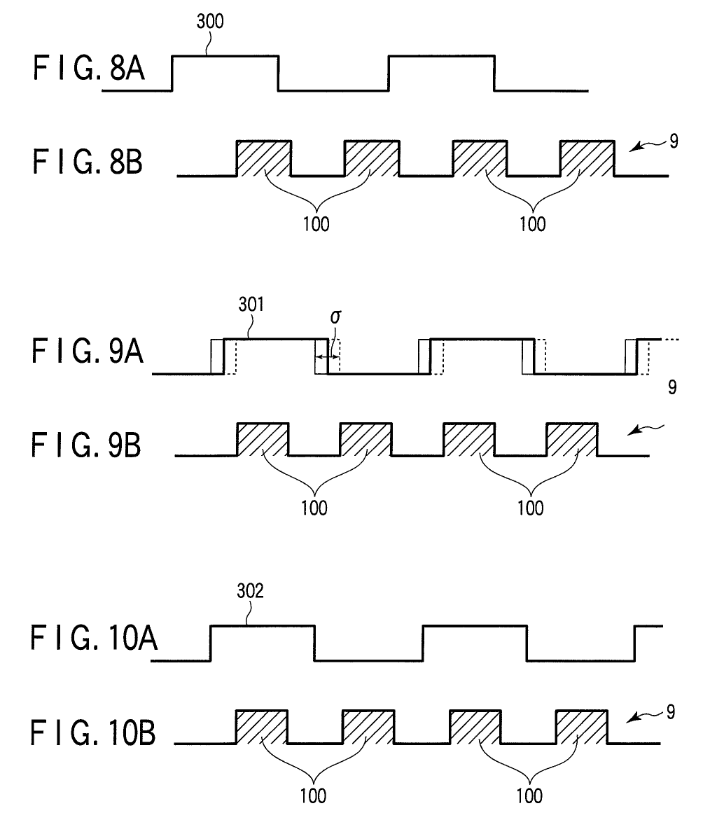

The magnetic disk drive configured as described above allows determination of a write clock signal serving to optimize the timing for a data write to the patterned medium 9. First, the principle of optimization of the write clock signal applied to the embodiment will be described with reference to FIGS. 8A, 8B, 9A, 9B, 10A, and 10B. FIGS. 8A, 8B, 9A, 9B, 10A, and 10B show the relationship between the magnetization of the magnetic dots and the phase of a write magnetic field in synchronism with the write clock signal. Each of FIGS. 8A, 9A, and 10A shows a write magnetic field. Each of FIGS. 8B, 9B, and 10B shows a cross section of the magnetic dots to which the magnetic field shown in the corresponding one of FIGS. 8A, 9A, and 10A is applied.

First, it is assumed that a write magnetic field 300 shown in FIG. 8A is applied to the magnetic dots 100 shown in FIG. 8B. In the examples in FIGS. 8A and 8B, the magnetization direction of the write magnetic field 300 is reversed on the magnetic dots 100. In this case, the magnetic dots 100 cannot completely be magnetized. That is, the write clock signal corresponding to the write magnetic field 300 is not optimum.

Now, it is assumed that a write magnetic field 301 shown by a thick line in FIG. 9A is applied to the magnetic dots 100 shown in FIG. 9B. The write magnetic field 301 has a phase obtained by shifting the phase of the write magnetic field 300 shown in FIG. 8A, by a given amount. In the example shown in FIGS. 9A and 9B, the magnetization direction of the write magnetic field 301 is reversed between the adjacent magnetic dots 100. In this case, the magnetic dots 100 are completely magnetized.

Here, the write magnetic field, for example, the write magnetic field 301 shown in FIG. 9A, involves a jitter σ as shown in FIG. 9A. Specifically, the jitter σ in the write magnetic field is represented by a Gaussian probability distribution with respect to a variation in write data, a variation in the property of a write module, or the like. These variations affect the write magnetic field 30 when data is written to the patterned medium 9 and appear as a variation in write magnetic field. Thus, this variation is called the jitter σ in the write magnetic field.

In view of the jitter σ, the magnetic dots 100 cannot completely be magnetized simply by reversing the magnetization direction of the write magnetic field between the adjacent magnetic dots 100. Thus, the write magnetic field 30 is used which is shown in FIG. 10A and which has a phase obtained by shifting the phase of the write magnetic field 300 shown in FIG. 8A, by a given amount. The magnetizing direction of the write magnetic field 302 shown in FIG. 10A is reversed at the exact midpoint between the adjacent magnetic dots 100 as shown in FIG. 10A. If such a write magnetic field 302 is applied to the magnetic dots 100, then taking the write magnetic field jitter σ into account makes the magnetic dots 100 most likely to be completely magnetized. The write clock signal corresponding to the write magnetic field 302 serves to optimize the timing for writing to the patterned medium 9.

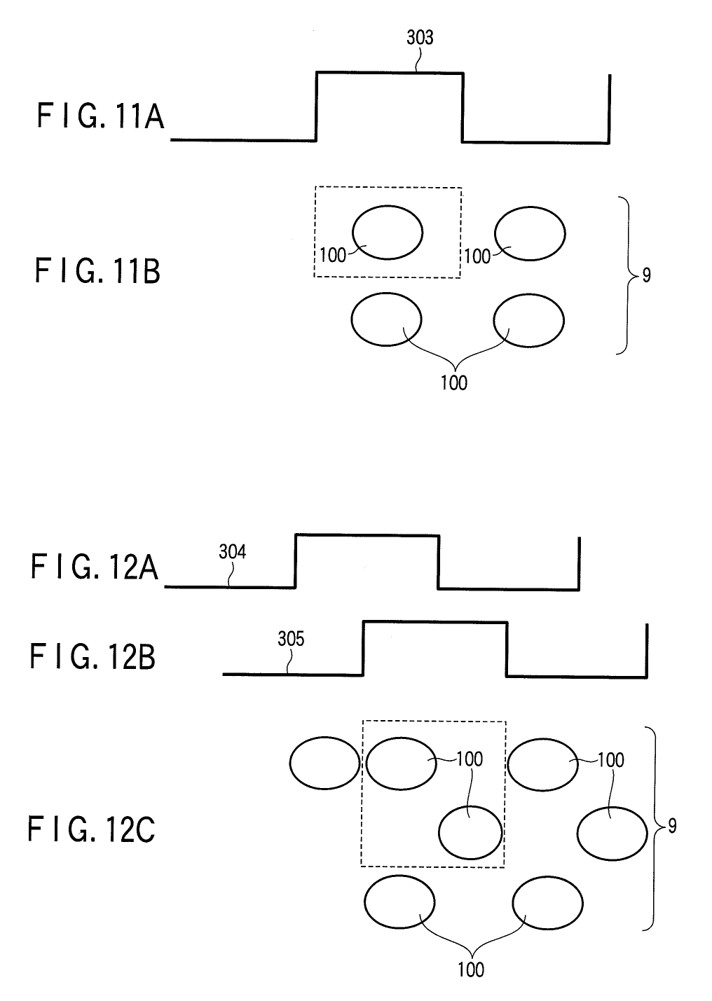

One bit in the patterned medium 9 applied to the embodiment need not necessarily comprise one magnetic dot 100. That is, 1 bit in the patterned medium 9 may comprise a plurality of magnetic dots 100. Thus, the relationship between magnetic dots and 1 bit in the patterned medium 9 will be described with reference to FIGS. 11A, 11B, 12A, 12B, and 12C.

FIGS. 11A and 11B show an example of the relationship between one magnetic dot and 1 bit in the patterned medium 9. FIGS. 12A, 12B, and 12C show an example of the relationship between a plurality of magnetic dots and 1 bit in the patterned medium 9. In FIGS. 11B and 12C, a portion enclosed by a dashed rectangle corresponds to 1 bit in the patterned medium 9. FIG. 11B shows that 1 bit comprises one magnetic dot 100. FIG. 12C shows that 1 bit comprises a plurality of magnetic dot 100.

If 1 bit comprises one magnetic dot 100 as shown in FIG. 11B, such a write clock signal may be generated as allows a write magnetic field 303 with the magnetization direction reversed at the midpoint between the adjacent magnetic dots 100 as shown in FIG. 11A to be applied to the magnetic dots 100. This enables 1 bit (that is, one magnetic dot 100) in the patterned medium 9 to be synchronized with the write clock signal.

If 1 bit comprises a plurality of magnetic dots 100 as shown in FIG. 12C, such a write clock signal may be generated as allows a write magnetic field 304 as shown ion FIG. 12A or a write magnetic field 305 as shown in FIG. 12B to be applied to the magnetic dots 100. This enables the bits in the patterned medium 9 to be synchronized with the write clock signal.

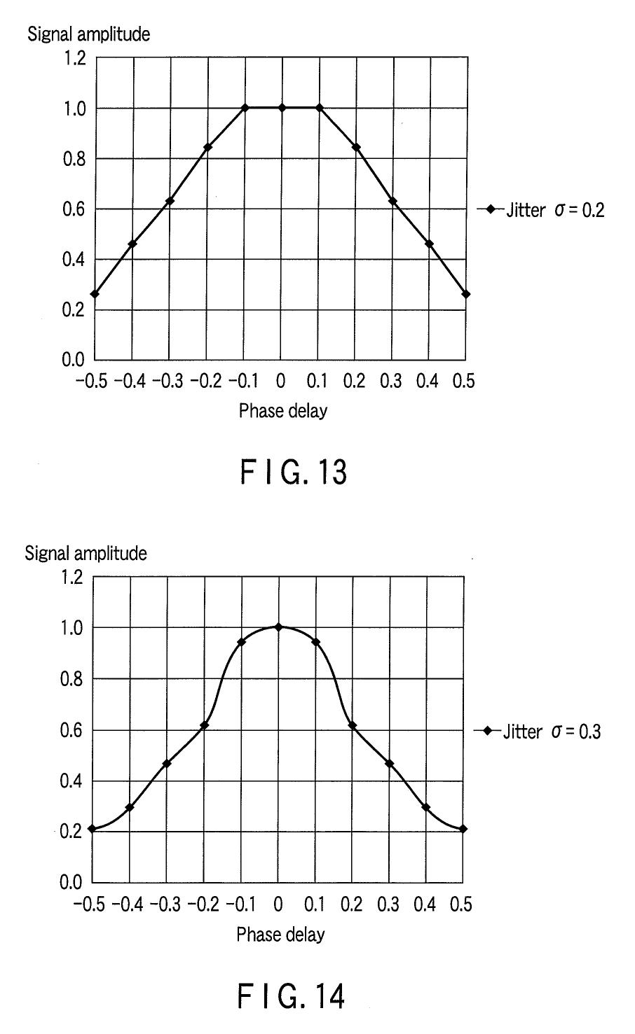

Now, with reference to FIGS. 13 and 14, description will be given of the technique by which the write clock generator 1 decides the phase delay required to generate a write clock signal in synchronism with the bits in the patterned medium 9 according to the embodiment. FIGS. 13 and 14 show the general relationship between the phase delay of the write magnetic field and the amplitude of the read signal when the jitter σ in the write magnetic field is 0.2 and 0.3, respectively.

In FIGS. 13 and 14, the axis of abscissa indicates the phase delay of the write magnetic field applied to the magnetic dots 100. The phase delay is based on the phase of the write magnetic field 302 with the magnetization direction reversed at the exact midpoint between the adjacent magnetic dots 100 as shown in FIGS. 10A and 10B. In FIGS. 13 and 14, the axis of ordinate indicates the amplitude of the read signal (signal amplitude) obtained when the data written to the patterned medium 9 by application of the write magnetic field is read.

As shown in FIGS. 13 and 14, if the jitter σ in the write magnetic field is either 0.2 or 0.3, the read signal has the maximum amplitude when the phase delay is zero. That is, the amplitude of the read signal is maximized if the magnetic dots 100 are subjected to the write magnetic field 302 with such a phase as allows the magnetization direction to be reversed at the exact midpoint between the adjacent magnetic dots 100. This means that a write clock signal is desirably generated such that the phase delay corresponds to the maximum amplitude of the read signal. If a write magnetic field generated based on such a write clock signal is applied to the magnetic dots 100, the magnetic dots 100 can obviously be completely magnetized.

In accordance with the principle described with reference to FIGS. 8A, 8B, 9A, 9B, 10A, and 10B, the write clock generator 1 determines a write clock signal that serves to optimize the timing for writing to the patterned medium 9. First, the delay controller 14 in the write clock generator 1 transmits phase delay data to the delay module 6 to instruct the delay module 6 to delay the phase of the reference write clock signal by the phase delay indicated by the phase delay data. Hence, the delay module 6 shifts the phase of the reference write clock signal input to the delay module 6, by the phase delay indicated by the phase delay data. The delay module 6 thus generates a reference write clock signal with the phase shifted, as a write clock signal.

Then, the repeated pattern write module 11 in the write clock generator 1 instructs the read/write module 2 to write data of the repeated pattern. Thus, based on the write clock signal generated by the delay module 6, the read/write module 2 writes the data on the repeated pattern to the data area 92 on the patterned medium 9. Then, the amplitude detector 12 in the write clock generator 1 instructs the read/write module 2 to read the data on the repeated pattern. Thus, the read/write module 2 reads the data on the repeated pattern written to the patterned medium 9 as a read signal. The amplitude detector 12 detects the amplitude of the read signal. The write clock generator 1 repeats the following operation with the phase delay varied.

The delay decision module 13 in the write clock generator 1 decides the phase delay for the reference write clock signal at which the amplitude of the read signal is maximized, based on the result of detection of the amplitude of the read signal acquired by the amplitude detector 12. The optimum amplitude, that is, a condition for determining the amplitude to be optimum, is, for example, that the amplitude is maximum. The delay decision module 13 stores the decided phase delay in the memory 8. More specifically, the delay decision module 13 stores the decided phase delay in the memory 8 in association with the current temperature. The phase delay stored in the memory 8 is applied to the reference write clock signal and is optimum for synchronizing the write clock signal with the magnetic dots. That is, the phase delay stored in the memory 8 serves to optimize the timing for writing to the patterned medium 9.

As described above, in the embodiment, the write clock generator 1 generates a write clock signal with a phase obtained by delaying the phase of the reference write clock signal by a certain phase delay. Then, based on the generated write clock signal, the write clock generator 1 writes data (repeated pattern) to the patterned medium. The write clock generator 1 reads the written data to detect the amplitude of the read signal. The write clock generator 1 repeats the series of operations with the phase delay varied. The write clock generator 1 then compares the amplitudes of the detected read signals for each phase delay to decide the phase delay for the reference write clock signal at which the magnitude of the amplitude is optimized. The write clock generator 1 then stores the decided phase delay in the memory 8.

After storing the phase delay in the memory 8, the write clock generator 1 reads the phase delay from the memory 8 when the read/write module 2 writes data to the data area 92 on the patterned medium 9. More specifically, the write clock generator 1 reads the phase delay associated with the temperature detected by the temperature sensor 7 when data is written. The write clock generator 1 then transmits phase delay data including the read phase delay to the delay module 6.

Upon receiving the phase delay data from the write clock generator 1, the delay module 6 generates a write clock signal by shifting the phase of the reference write clock signal by the phase delay specified in the phase delay data as shown in FIG. 3. The generated write clock signal synchronizes with the bits in the patterned medium 9. That is, based on the reference write clock signal and the phase delay stored in the memory 8, the write clock generator 1 generates a write clock signal that is appropriate for writing data to the bits in the patterned medium 9.

The delay decision module 13 may decide the phase delay based on the amplitude of the average waveform of the read signal in the direction of the time axis, that is, the time average amplitude of the read signal. Furthermore, as shown in a first modification described below, the delay decision module 13 may decide the phase delay based on the amplitude of the fundamental wave component of the read signal.

In the embodiment, the relationship between the phase delay specified by the delay controller 14 and the current temperature is not particularly limited. However, for example, with reference to the data stored in the memory 8 and indicating the correspondence between the temperature and the phase delay shown in FIG. 7, the delay controller 14 may decide the phase delay corresponding to the current temperature in the magnetic disk drive detected by the temperature sensor 7. In this case, the delay controller 14 instructs the delay module 6 to generate a write clock signal by delaying the reference write clock signal, which is an output signal from VCO 5, by the phase delay corresponding to the current temperature. Thus, a write clock signal can be generated using the optimum phase delay corresponding to the temperature detected while writing. Consequently, an error rate dependent on the temperature can be reduced.

### First Modification

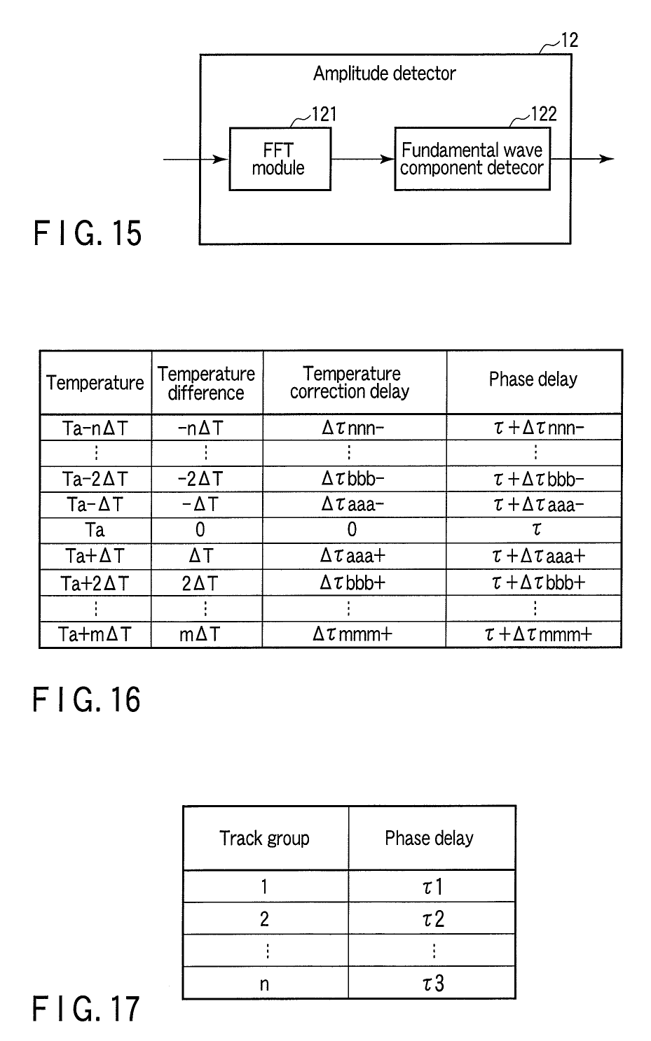

Now, a first modification of the embodiment will be described with reference to FIG. 15. FIG. 15 is a block diagram showing the configuration of the amplitude detector 12 applied to the first modification. For example, as shown in FIG. 11, the amplitude detector 12 shown in FIG. 15 comprises a fast Fourier transform module (FFT module) 121 and a fundamental wave component detector 122. The FFT module 121 subjects read signals to, for example, a finite Fourier transformation or a discrete Fourier transformation. The fundamental component detector 122 detects the amplitude of a fundamental wave component output by the FFT module 121. The delay decision module 13 decides the phase delay based on the amplitude of the fundamental wave component of the read signal detected by the fundamental wave component detector 122.

### Second Modification

Now, a second modification of the embodiment will be described with reference to FIG. 16. FIG. 16 shows an example of data stored in the memory 8 and including the phase delay according to the second modification. In the second modification, as is the case with the embodiment, the delay decision module 13 decides the phase delay for each temperature in the magnetic disk drive. Then, for example, as shown in FIG. 16, the delay decision module 13 stores a temperature correction delay and the phase delay in the memory 8 in association with the temperature and the difference between the temperature and a reference temperature Ta (temperature difference). The temperature correction delay refers to the correction corresponding to the temperature difference with respect to the optimum phase delay τ corresponding to the reference temperature Ta. The phase delay is optimal. Thus, the temperature correction enables a variation in the delay property of the write driver 102 which is dependent on the temperature to be reduced.

In the second modification, the delay controller 14 references the data stored in the memory 8 and shown in FIG. 16 to decide the phase delay corresponding to the difference between the reference temperature Ta and the current temperature detected by the temperature sensor 7. The delay controller 14 instructs the delay module 6 to generate a write clock signal by delaying the reference write clock signal by the decided phase delay.

### Third Modification

Now, a third modification of the embodiment will be described with reference to FIG. 17. FIG. 17 shows an example of data stored in the memory 8 and including the phase delay according to the third modification. In the third embodiment, for management, a set of tracks on the patterned medium 9 is divided into a plurality of track groups in the radial direction of the patterned medium 9. Each of the plurality of track groups comprises a plurality of tracks.

For every track group on the patterned medium 9, the repeated pattern write module 11 writes a repeated pattern to the data area 92 in the corresponding track group. The amplitude detector 12 detects the amplitude of a read signal for the repeated pattern for each track group on the patterned medium 9. The delay decision module 13 decides the phase delay for each track group based on the result of detection of the amplitude of the read signal for each track group, which amplitude is acquired by the amplitude detector 12. For example, as shown in FIG. 17, the delay decision module 13 stores the decided phase delay in the memory 8 in association with the track group. Based on the phase delay for each track group stored in the memory 8, the phase delay for each track can be decided by utilizing an interpolation method in accordance with the angular dependence of the yaw angle.

In the third variation, the delay controller 14 references data stored in the memory 8 and shown in FIG. 17 to decide the phase delay corresponding to a particular track group; the track (target track) to which the data is to be written belongs to this target block. The delay controller 14 instructs the delay module 6 to generate a write clock signal by delaying the reference write signal by the decided phase delay. This enables a reduction in the rate of errors caused by the dependence of the relative difference between the write head 101 and the read head 103 on the radial position on the patterned medium 9.

[Write Clock Signal Generating Process]

Now, a write clock signal generating process according to the embodiment will be described in brief. The write clock signal generating process according to the embodiment is roughly divided into a detecting step, a repeating step, a phase delay decision step, and a storing step.

In the detecting step, the write clock generator 1 generates a write clock signal by delaying the phase of the reference write clock signal by a given phase delay. Based on the generated write clock signal, the write clock generator 1 writes data (for example, a repeated pattern) to the patterned medium 9. The write clock generator 1 reads the written data to detect the amplitude of the read signal.

In the repeating step, the write clock generator 1 repeats the detecting step with the given phase delay varied. In the phase delay decision step, the write clock generator 1 compares the amplitudes of the read signals detected during the repeating step. The write clock generator 1 thus decides the phase delay for the reference write clock signal at which the amplitude is optimized. In the storing step, the write clock generator 1 stores the phase delay decided in the phase delay decision step, in the memory 8.

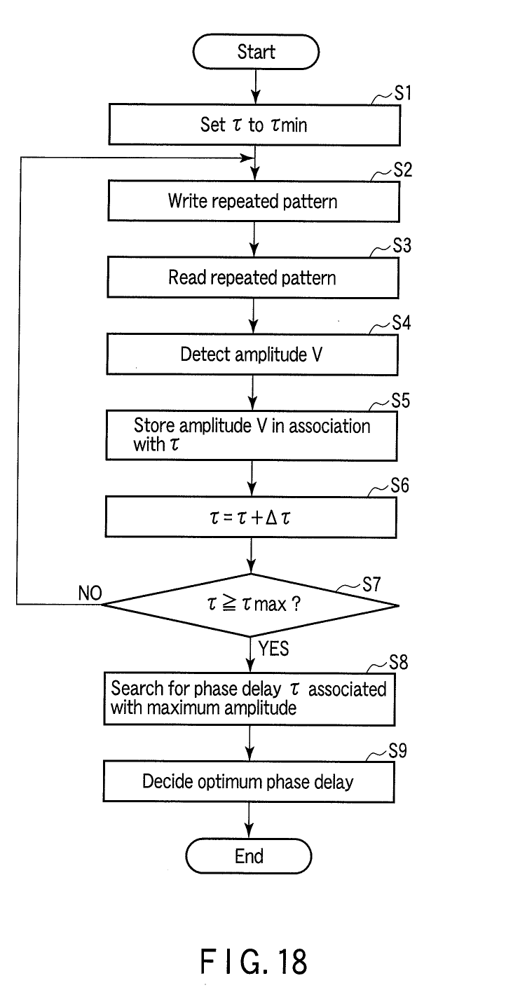

Now, the write clock signal generating process according to the embodiment will be described in detail with reference to a flowchart in FIG. 18. First, the repeated pattern write module 11 in the write clock generator 1 sets the phase delay τ to a given minimum τmin (block S1). Then, the repeated pattern write module 11 uses a write clock signal generated based on the phase delay τ to write the repeated pattern to the data area 92 (more specifically, the data sector 920 in the data area 92) on the patterned medium 9 (block S2).

The read/write module 2 reads the repeated pattern written to the data area 92 in block S2 (block S3). The amplitude detector 12 detects the amplitude V of the read signal for the repeated pattern read in block S3 (block S4). Then, the amplitude detector 12 stores the detected amplitude V in a predetermined storage device in association with the phase delay τ (block S5). The storage device may be the memory 8.

The repeated pattern write module 11 increments the phase delay τ by a given amount Δτ (block S6). Then, the delay decision module 13 determines whether or not the phase delay τ is greater than or equal to a given maximum phase delay max serving as an end condition (block S7). If the delay decision module 13 determines that the phase delay τ is less than max (NO in block S7), the above-described block S2 is executed again. Then, blocks S2 to S7 are similarly repeated until the phase delay τ becomes at least max, that is, until the phase delay τ meets the end condition.

It is assumed that the delay decision module 13 later determines that the phase delay τ is at least max (YES in block S7). In this case, the delay decision module 13 searches for the phase delay τ associated with the maximum one of the amplitudes V stored in the storage device (block S8). Then, the delay decision module 13 decides the obtained phase delay τ (that is, the phase delay τ associated with the maximum amplitude) to be optimum. The delay decision module 13 then stores the decided phase delay τ in the memory 8 (block S9).

As described above, the write clock signal generating process applied to the embodiment and shown in the flowchart in FIG. 18 focuses on the fact that the amplitude of the read signal for the repeated pattern is maximized if the repeated pattern is written in synchronism with the bits in the patterned medium 9. That is, in the write clock signal generating process shown in FIG. 18, the phase delay corresponding to the maximum amplitude of the read signal is decided to be optimum. This enables easy decision of a write clock signal serving to optimize the timing for writing to the patterned medium 9.

### Fourth Modification

Now, a fourth modification of the embodiment will be described. A write clock signal generating process based on a procedure different from that of the embodiment is applied to the fourth embodiment. Thus, the write clock signal generating process according to the fourth modification will be described in brief.

First, in a detecting step, the repeated pattern write module 11 in the write clock generator 1 uses a write clock signal generated based on a phase delay τ to write a repeated pattern to the data area 92 on the patterned medium 9. The amplitude detector 12 detects the amplitude V of the read signal for the repeated pattern. The amplitude detector 12 then stores the phase delay τ and the amplitude V in a predetermined storage device in association with each other.

In a phase delay decision step, the delay decision module 13 compares the detected amplitude V (that is, the amplitude of the read signal for the currently written repeated pattern) with the amplitude Vo of the read signal for the last written repeated pattern. Then, based on the result of the comparison, the delay decision module 13 decides the optimum phase delay. In the storing step, the delay decision module 13 stores the decided optimum phase delay in the memory 8.

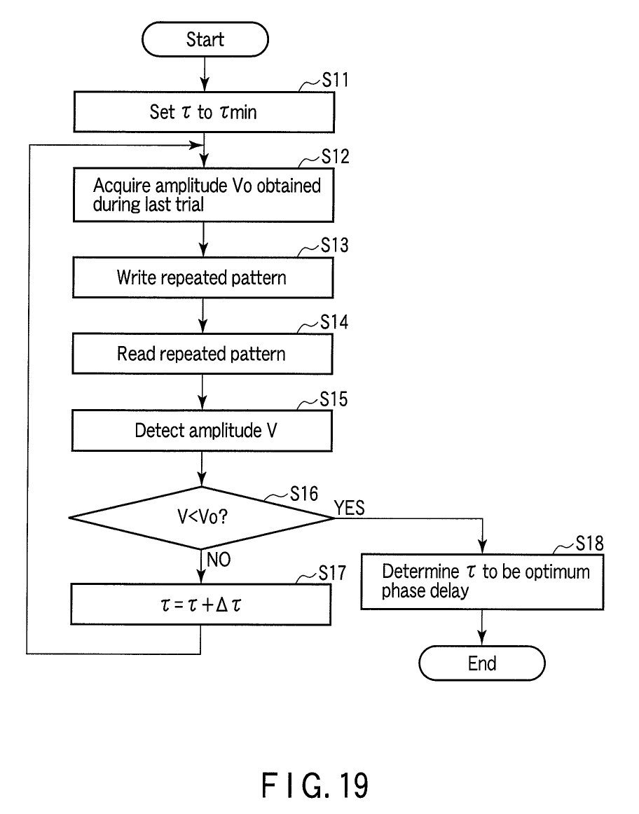

Now, the write clock signal generating process according to the fourth modification will be described with reference to a flowchart in FIG. 19. First, the repeated pattern write module 11 in the write clock generator 1 sets the phase delay τ to a given minimum τmin (block S11). Then, the delay decision module 13 acquires the amplitude V obtained during the last trial, as the amplitude Vo (block S12). Here, in the case of the first trial, a given minimum amplitude Vmin is used as the amplitude Vo obtained during the last trial.

Then, the repeated pattern write module 11 uses a write clock signal generated based on the phase delay τ to write the repeated pattern to the data area 92 on the patterned medium 9 (block S13). The read/write module 2 reads the repeated pattern written to the data area 92 (block S14). The amplitude detector 12 detects the amplitude V of the read signal for the read repeated pattern (block S15).

The delay decision section 13 determines whether or not the detected amplitude V is smaller than Vo (block S16). If the phase decision module 13 determines that the amplitude V is not smaller than Vo (NO in block S16), the repeated pattern write module 11 increases the phase delay τ by Δ96 (block S17). Then, the process returns to the above-described block S12. In this manner, blocks S17 and S12 to S16 are repeated until the amplitude V becomes smaller than the amplitude Vo obtained during the last trial.

It is assumed that the delay decision module 13 determines that the amplitude V is smaller than Vo (YES in block S16). In this case, the delay decision module 13 decides the current phase delay τ to be optimum and stores this phase delay τ in the memory 8 (block S18).

As described above, in the write clock signal generating process applied to the fourth modification and shown in FIG. 19, the amplitude V of the read signal for the currently written repeated pattern is compared with the amplitude Vo of the read signal for the last written repeated pattern. Then, based on the result of the comparison, the optimum phase delay is decided. Thus, the write clock signal serving to optimize the timing for writing to the patterned medium 9 can be easily decided.

### Fifth Modification

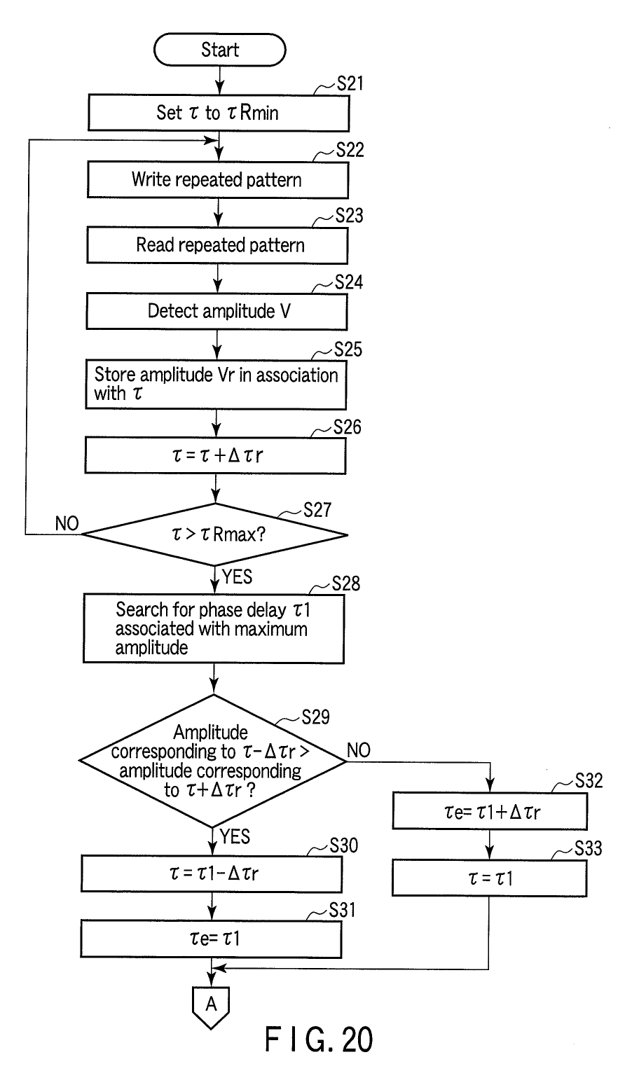

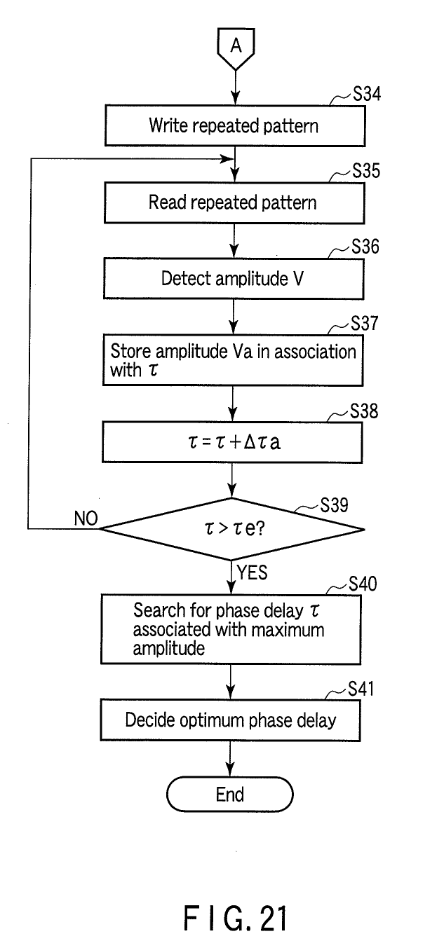

Now, a fifth modification of the embodiment will be described. A write clock signal generating process based on a procedure different from those of the embodiment and the fourth modification is applied to the fifth embodiment. Thus, the write clock signal generating process according to the fifth modification will be described in detail with reference to a flowchart in FIGS. 20 and 21.

First, the repeated pattern write module 11 in the write clock generator 1 sets the phase delay τ to a given coarse adjustment minimum τRmin (block S21). Then, the repeated pattern write module 11 uses a write clock signal generated based on the phase delay τ to write the repeated pattern to the data area 92 on the patterned medium 9 (block S22).

The read/write module 2 reads the repeated pattern written to the data area 92 (block S23). The amplitude detector 12 detects the amplitude Vr of the read signal for the read repeated pattern (block S24). The amplitude detector 12 then stores the detected amplitude Vr in a predetermined storage device in association with the phase delay τ (block S25).

The repeated pattern write module 11 increments the phase delay τ by a given amount Δτr (block S26). Then, the delay decision module 13 determines whether or not the phase delay τ is greater than a given maximum phase delay τRmax serving as an end condition (block S27). If the delay decision module 13 determines that the phase delay τ is not greater than τRmax (NO in block S27), the above-described block S22 is executed again. Then, blocks 22 to 27 are similarly repeated until the phase delay τ becomes greater than τRmax.

It is assumed that the delay decision module 13 later determines that the phase delay τ is greater than τRmax (YES in block S27). In this case, the delay decision module 13 searches for a phase delay τ1 associated with the maximum one of the amplitudes V stored in the storage device (block S28). Then, the delay decision module 13 determines whether or not the amplitude corresponding to τ1−Δτr is greater than that corresponding to τ1+Δτr (block S29).

If the delay decision module 13 determines that the amplitude corresponding to τ1−Δτr is greater than that corresponding to τ1+Δτr (YES in block S29), the repeated pattern write module 11 decides τ1-Δτr to be the phase delay τ (block S30). Furthermore, the repeated pattern write module 11 decides τ1 to be τe (block S31). Then, the repeated pattern write module 11 proceeds to block S34.

In contrast, if the delay decision module 13 determines that the amplitude corresponding to τ1−ττr is not greater than that corresponding to τ1+Δτr (NO in block S29), the repeated pattern write module 11 decides τ1+Δτr to be the phase delay τe (block S32). Furthermore, the repeated pattern write module 11 decides τ1 to be τ (block S33). Then, the repeated pattern write module 11 proceeds to block S34.

In block S34, the repeated pattern write module 11 uses a write clock signal generated based on the predetermine phase delay τ to write a repeated pattern to the data area 92 on the patterned medium 9 (block S34). The read/write module 2 reads the repeated pattern written to the data area 92 (block S35). The amplitude detector 12 detects the amplitude Va of the read signal for the read repeated pattern (block S36). The amplitude detector 12 then stores the detected amplitude Va in a predetermined storage device in association with the phase delay τ (block S37).

The repeated pattern write module 11 increments the phase delay τ by a given amount Δτa (block S38). Then, the delay decision module 13 determines whether or not the phase delay τ is greater than τe (block S39). If the delay decision module 13 determines that the phase delay τ is not greater than τe (NO in block S39), the above-described block S34 is executed again. Then, blocks 34 to 39 are similarly repeated until the phase delay τ becomes greater than τe.

It is assumed that the delay decision module 13 later determines that the phase delay τ is greater than τe (YES in block S39). In this case, the delay decision module 13 searches for the phase delay τ associated with the maximum one of the amplitudes Va stored in the storage device (block S40). Then, the delay decision module 13 decides the obtained phase delay τ (that is, the phase delay τ associated with the maximum amplitude) to be optimum. The delay decision module 13 stores the optimum phase delay τ in the memory 8 (block S41).

As described above, in the write clock signal generating process applied to the fifth modification and shown in the flowchart in FIGS. 20 and 21, the range including the optimum phase delay is extracted by coarse adjustment. If the amplitude corresponding to τ1−Δτr is greater than that corresponding to τ1+Δτ (YES in block S29), the upper limit (τe) and lower limit of the extracted range are τ1 and τ1−Δτr, respectively. If the amplitude corresponding to τ1−Δτr is not greater than that corresponding to τ1+Δττ (NO in block S29), the upper limit (τe) and lower limit of the extracted range are τ1+Δτr and τ1, respectively. In the fifth modification, the optimum phase delay is decided by fine-tuning the phase delay τ within the extracted range. Thus, the optimum phase delay can be accurately decided.

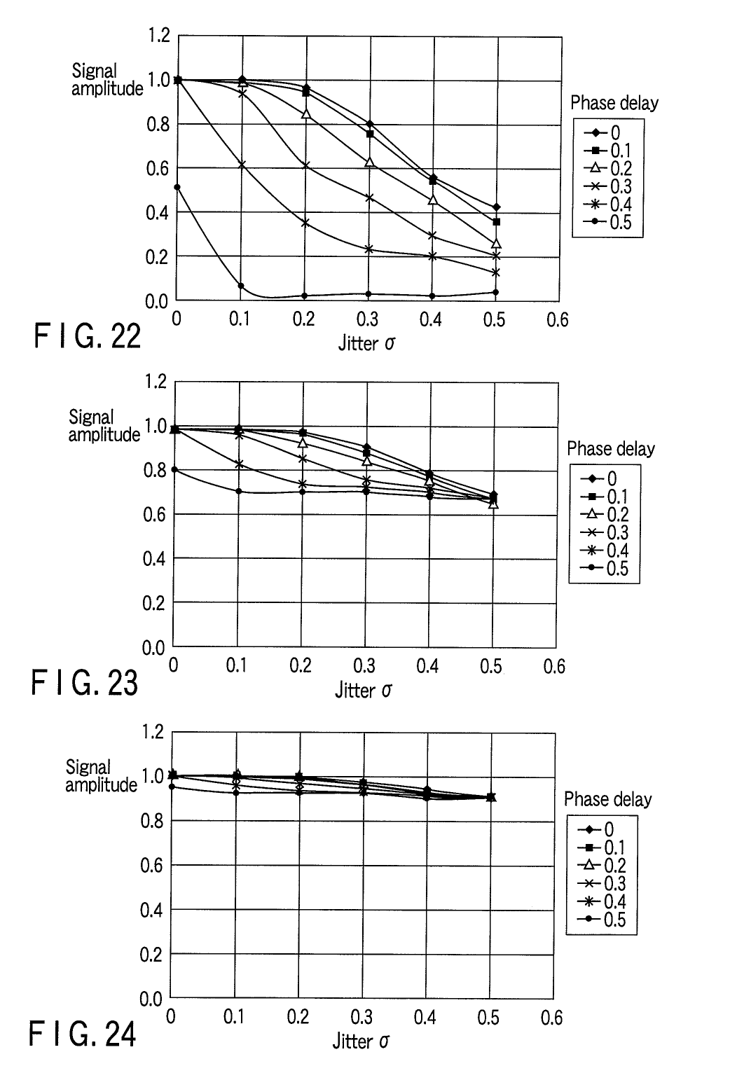

FIGS. 22 to 24 show an example of the result of detection of the signal amplitude corresponding to the jitter σ in the write magnetic field. FIG. 22 shows an example of the signal amplitude corresponding to the jitter σ in the write magnetic field resulting from reversal of the magnetization direction of the repeated pattern for every 1 bit in the patterned medium 9. The signal amplitude belongs to the fundamental wave component of the repeated pattern. Six detection results in FIG. 22 show the signal amplitudes obtained when the repeated pattern is written to the patterned medium 9 and corresponding to respective different timings (that is, the different phase delays). For example, “phase delay=0” indicates that the magnetization direction is reversed at the midpoint between the adjacent magnetic dots 100 on the patterned medium 9. The signal amplitudes in FIG. 22 are normalized based on the amplitude obtained under both the following conditions: the jitter σ in the write magnetic field is zero, and “phase delay=0”.

FIG. 23 shows an example of the signal amplitude corresponding to the jitter σ in the write magnetic field resulting from reversal of the magnetization direction of the repeated pattern for every 2 bits in the patterned medium 9. That is, the period of the repeated pattern in the example shown in FIG. 23 is double that of the repeated pattern in the example shown in FIG. 22. FIG. 24 shows an example of the signal amplitude corresponding to the jitter σ in the write magnetic field resulting from reversal of the magnetization direction of the repeated pattern for every 4 bits in the patterned medium 9. That is, the period of the repeated pattern in the example shown in FIG. 24 is four times as long as that of the repeated pattern in the example shown in FIG. 22.

As is apparent from FIG. 22, the signal amplitude decreases with increasing jitter σ in the write magnetic field. Furthermore, as is apparent from FIG. 22, the signal amplitude decreases as the phase delay increases, that is, as the position where the magnetization direction is reversed deviates from the midpoint between the adjacent magnetic dots 100 and approaches the center of each magnetic dot 100. In the example shown in FIG. 22, if the jitter σ in the write magnetic field has a certain magnitude, for example, about 0.1, a phase delay apparently reduces the signal amplitude.

In contrast, an increase in the period of the repeated pattern reduces the change rate of the signal amplitude corresponding to the phase delay even with the same jitter σ in the write magnetic field, as shown in FIGS. 23 and 24. In this case, the decision of the optimum phase delay is difficult. Hence, the period of the repeated pattern is desirably shorter. It is best to reverse the magnetization direction for every 1 bit in the patterned medium 9 while writing the repeated pattern.

The various modules of the magnetic disk drive described herein can be implemented as software applications, hardware and/or software modules. While the various modules are illustrated separately, they may share some or all of the same underlying logical or code.

While certain embodiments of the inventions have been described, these embodiments have been presented by way of example only, and are not intended to limit the scope of the inventions. Indeed, the novel apparatuses and methods described herein may be embodied in a variety of other forms; furthermore, various omissions, substitutions and changes in the form of the apparatuses and methods described herein may be made without departing from spirit of the inventions. The accompanying claims and their equivalents are intended to cover such forms or modifications as would fall within the scope and spirit of the inventions.

What is claimed is:

1. A method for generating a write clock signal in a magnetic disk drive, the method comprising:
generating a write clock signal with a phase delayed with respect to a reference write clock signal;
writing predetermined data to bits in a magnetic recording medium based on the generated write clock signal, each bit comprising one or more isolated magnetic dots arranged on the magnetic recording medium;
detecting an amplitude of a read signal for the written predetermined data;
repeating the generation of a write clock signal, the writing of predetermined data, and the detecting of an amplitude, with a varied phase delay; and
determining an optimum phase delay for generating the write clock signal when data is written to the magnetic recording medium, based on the amplitude detected for each phase delay.

2. The method of claim 1, further comprising storing the optimum phase delay in a memory.

3. The method of claim 1, wherein the predetermined data is a repeated pattern of a uniform frequency.

4. The method of claim 3, wherein the repeated pattern has a half period corresponding to a minimum unit of the magnetic dots.

5. The method of claim 3, wherein the repeated pattern has a half period corresponding to 1 bit in the magnetic recording medium.

6. The method of claim 1, wherein the optimum phase delay is determined based on a time average amplitude detected for each phase delay.

7. The method of claim 1, wherein the detected amplitude is the amplitude of a fundamental wave of the read signal.

8. The method of claim 1, wherein:
the amplitude of the read signal is detected for each temperature of the magnetic disk drive, and
the optimum phase delay is determined for each temperature.

9. The method of claim 1, wherein:
the amplitude of the read signal is detected for each temperature of the magnetic disk drive, and
the optimum phase delay is determined for each difference between a reference temperature and the temperature of the magnetic disk drive.

10. The method of claim 1, wherein:
the generation of a write clock signal, the writing of predetermined data, and the detecting of an amplitude comprises incrementing the phase delay by a predetermined amount in accordance with the detection of the amplitude; and
repeating the generation, the writing, and the detecting based on the incremented phase delay, if the incremented phase delay is not greater than a maximum phase delay; and
the optimum phase delay is determined based on the amplitude detected for each phase delay, if the incremented phase delay is greater than the maximum phase delay.

11. The method of claim 1, wherein:
the generation of a write clock signal, the writing of predetermined data, and the detecting of an amplitude comprises (a) comparing a newly detected first amplitude V with a last detected second amplitude Vo, and (b) incrementing the phase delay by a predetermined amount if the first amplitude V is not smaller than the second amplitude Vo;
the generation of a write clock signal, the writing of predetermined data, and the detecting of an amplitude are repeated based on the incremented phase delay; and
the optimum phase delay is determined based on the amplitude detected for each phase delay, if the first amplitude V is smaller than the second amplitude Vo.

12. The method of claim 1, wherein the optimum phase delay is a phase delay corresponding to one of the detected amplitudes meeting a predetermined condition.

13. The method of claim 12, wherein a maximum detected amplitude meets the predetermined condition.

14. A magnetic disk drive comprising:
a magnetic recording medium comprising a plurality of bits comprising one or more isolated magnetic dots; and
a write clock generator configured to generate a write clock signal with a phase obtained by delaying a phase of a reference write clock signal, comprising:
a write module configured to write predetermined data to the bits based on the generated write clock signal;
an amplitude detector configured to detect an amplitude of a read signal for the written predetermined data; and
a delay decision module configured to repeatedly control the write module and the amplitude detector with a varied phase delay, and to decide an optimum phase delay for generating the write clock signal when data is written to the magnetic recording medium, based on the amplitude detected for each phase delay.

15. The magnetic disk drive of claim 14, further comprising a memory configured to store the optimum phase delay.

16. The magnetic disk drive of claim 15, wherein the write clock generator is configured to generate the write clock signal based on the optimum phase delay in the memory.

17. The magnetic disk drive of claim 14, wherein the predetermined data is a repeated pattern of a uniform frequency.

18. The magnetic disk drive of claim 14, further comprising a reference write clock generator configured to generate the reference write clock signal based on data pre-written to the magnetic recording medium.

19. The magnetic disk drive of claim 14, wherein the optimum phase delay is a phase delay corresponding to one of the detected amplitudes meeting a predetermined condition.
